(19) United States
(12) Patent Application Publication
(10) Pub. No.: US 2023/0279842 A1
(43) Pub. Date: Sep. 7, 2023

(54) MANUFACTURING METHOD FOR WIND TURBINE GENERATOR SYSTEM, AND WIND TURBINE GENERATOR SYSTEM

(71) Applicant: TOYOTA JIDOSHA KABUSHIKI KAISHA, Toyota-shi Aichi-ken (JP)

(72) Inventors: Eiji ITO, Susono-shi Shizuoka-ken (JP); Kunihiro KOBAYASHI, Toyota-shi Aichi-ken (JP); Sou MORISHITA, Nagoya-shi Aichi-ken (JP)

(73) Assignee: TOYOTA JIDOSHA KABUSHIKI KAISHA, Toyota-shi Aichi-ken (JP)

(21) Appl. No.: 18/091,799

(22) Filed: Dec. 30, 2022

(30) Foreign Application Priority Data
Mar. 2, 2022 (JP) 2022-032045

(51) Int. Cl. F03D 15/00; H02K 7/116; H02K 7/18; H02K 11/25

(52) U.S. Cl. CPC F03D 15/00; H02K 7/116; H02K 7/183; H02K 11/25; F05B 2230/60; F05B 2260/40311

(57) ABSTRACT

A manufacturing method for a wind turbine generator system is provided. The manufacturing method includes preparing a transaxle that includes a drive motor generator and that is intended for a hybrid electric vehicle, and assembling a blade to a rotary shaft coupled to the drive motor generator in the prepared transaxle.

### CROSS-REFERENCE TO RELATED APPLICATION

This application claims priority to Japanese Patent Application No. 2022-032045 filed on Mar. 2, 2022, incorporated herein by reference in its entirety.

### BACKGROUND

### 1. Technical Field

The disclosure relates to a manufacturing method for a wind turbine generator system, and a wind turbine generator system.

### 2. Description of Related Art

Japanese Unexamined Patent Application Publication No. 2003-336571 (JP 2003-336571 A) describes a wind turbine generator system including a motor generator, a transmission, a rotary shaft, and the like.

### SUMMARY

From the concept of a recycling society, it is conceivable to apply parts in fields other than wind power generation to wind turbine generator systems. For example, transaxle parts of a hybrid electric vehicle include a motor, a transmission, a rotary shaft, and the like, and using the parts in a wind turbine generator system leads to the effective use of resources. The disclosure provides a technology for promoting such an approach to achieve a sustainable society.

A first aspect of the disclosure provides a manufacturing method for a wind turbine generator system. The manufacturing method includes preparing a transaxle including a drive motor generator and intended for a hybrid electric vehicle. The manufacturing method includes assembling a blade to a rotary shaft coupled to the drive motor generator in the prepared transaxle.

With the above manufacturing method, a transaxle mounted on a hybrid electric vehicle is able to be used as part of a wind turbine generator system. Since transaxles are mass-produced vehicle parts, the transaxles are much more inexpensive than parts for wind power generation. Wind turbine generator systems can be provided at low cost, so it is possible to promote further proliferation of renewable energy.

In the manufacturing method, the rotary shaft of the transaxle may be a shaft connected to a wheel of the hybrid electric vehicle when the transaxle is mounted on the hybrid electric vehicle.

In the manufacturing method, the transaxle may include a planetary gear train, and

the rotary shaft may be connected to the drive motor generator via the planetary gear train.

In the manufacturing method, the transaxle may include a power motor generator, and the rotary shaft may also be connected to the power motor generator via the planetary gear train.

In the manufacturing method, the planetary gear train may include a sun gear connected to the power motor generator, and a ring gear connected to the drive motor generator and the blade.

A second aspect of the disclosure provides a wind turbine generator system. The wind turbine generator system includes a blade, a first motor generator, a second motor generator, and a planetary gear train including a sun gear, a ring gear, and a planetary carrier. The first motor generator is coupled to the sun gear. The blade and the second motor generator are coupled to the ring gear.

With the above wind turbine generator system, a driving torque input from the blade is able to be distributed by the planetary gear train to between the first motor generator and the second motor generator. Thus, it is possible to optimize the overall power generation efficiency of the first and second motor generators.

In the above wind turbine generator system, a ratio between a rotation speed of the second motor generator and a rotation speed of the blade may be fixed, and a ratio between a rotation speed of the first motor generator and the rotation speed of the blade may be adjustable.

The wind turbine generator system may further include a mechanical oil pump coupled to the planetary carrier, and the mechanical oil pump may be configured to supply oil to component parts of the wind turbine generator system in response to rotation of the planetary carrier.

In the above wind turbine generator system, the planetary gear train may be configured to change in state between a first state where the ring gear is rotating in a forward direction and the sun gear is rotating in a reverse direction and a second state where the ring gear, the planetary carrier, and the sun gear are rotating in the forward direction, and, in the second state, the first motor generator may be configured to generate a torque in a forward rotation direction.

The above wind turbine generator system may further include a control unit configured to control a power generation torque of the first motor generator and a power generation torque of the second motor generator, the first motor generator may be a motor generator having a smaller starting torque than the second motor generator, the control unit may be configured to generate electric power by using the first motor generator when an input torque input from the blade is less than a predetermined value, and the control unit may be configured to generate electric power by using the first motor generator and the second motor generator when the input torque is greater than the predetermined value.

The above wind turbine generator system may further include a control unit configured to control a power generation torque of the first motor generator and a power generation torque of the second motor generator, and a temperature sensor configured to measure a temperature of the first motor generator and a temperature of the second motor generator, and the control unit may be configured to reduce the power generation torque as the temperature measured by the temperature sensor increases.

In the above wind turbine generator system, the wind turbine generator system may be a system for a hybrid electric vehicle, the ring gear may be coupled to a wheel, and the planetary carrier may be coupled to an output shaft of an engine.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram that schematically shows a state where a hybrid unit of a hybrid electric vehicle is used as part of a wind turbine generator system;

FIG. 2 is a diagram that schematically shows the configuration of the hybrid electric vehicle on which the hybrid unit is mounted;

FIG. 3 is a diagram that schematically shows the configuration of the wind turbine generator system in which the hybrid unit is used;

FIG. 4 is an example of a nomograph of a state where electric power is being generated by a second motor generator;

FIG. 5 is an example of a nomograph of a state where electric power is being generated by a first motor generator and the second motor generator;

FIG. 6 is an example of a nomograph in a planetary lock state; and

FIG. 7 is a graph that shows an example of a power curve of the wind turbine generator system.

### DETAILED DESCRIPTION OF EMBODIMENTS

In one embodiment of the technology, the rotary shaft of the transaxle may be a shaft connected to a wheel of the hybrid electric vehicle when the transaxle is mounted on the hybrid electric vehicle. With such a configuration, as in the case of power generation using a wheel in a hybrid electric vehicle, it is possible to efficiently generate electric power by rotation of a blade in a wind turbine generator system. As another embodiment, the rotary shaft of the transaxle may be an engine shaft connected to an engine when the transaxle is mounted on the hybrid electric vehicle.

In one embodiment of the technology, the transaxle may further include a planetary gear train. In this case, the rotary shaft of the transaxle may be connected to the drive motor generator via the planetary gear train.

In the above-described embodiment, the transaxle may further include a power motor generator. In this case, the rotary shaft of the transaxle may be connected to the power motor generator via the planetary gear train. With such a configuration, the wind turbine generator system is able to generate electric power by using two motor generators. However, even when the transaxle includes two motor generators, the wind turbine generator system may generate electric power by using only one of the motor generators.

In the above-described embodiment, the planetary gear train may include a sun gear connected to the power motor generator, and a ring gear connected to the drive motor generator and the blade.

In one embodiment of the technology, a ratio between a rotation speed of the second motor generator and a rotation speed of the blade may be fixed. A ratio between a rotation speed of the first motor generator and the rotation speed of the blade may be adjustable. With such a configuration, the rotation speed of the first motor generator is able to be adjusted to a selected value. It is possible to increase the energy conversion efficiency of the first motor generator.

In one embodiment of the technology, the wind turbine generator system may further include a mechanical oil pump coupled to the planetary carrier. The mechanical oil pump may be configured to supply oil to component parts of the wind turbine generator system in response to rotation of the planetary carrier. With such a configuration, it is possible to cool and lubricate component parts of the wind turbine generator system by rotation of the planetary carrier.

In one embodiment of the technology, the planetary gear train may be configured to change in state between a first state where the ring gear is rotating in a forward direction and the sun gear is rotating in a reverse direction and a second state where the ring gear, the planetary carrier, and the sun gear are rotating in the forward direction. In the second state, the first motor generator may be configured to generate a torque in a forward rotation direction. With such a configuration, the first motor generator generates a torque in the forward rotation direction to make it possible to shift from the first state to the second state. In the second state, the planetary carrier is able to be rotated, so oil is able to be supplied by using the mechanical oil pump.

In one embodiment of the technology, the wind turbine generator system may further include a control unit configured to control a power generation torque of the first motor generator and a power generation torque of the second motor generator. The first motor generator may be a motor generator having a smaller starting torque than the second motor generator. The control unit may be configured to generate electric power by using the first motor generator when an input torque input from the blade is less than a predetermined value. The control unit may be configured to generate electric power by using the first motor generator and the second motor generator when the input torque is greater than the predetermined value. With such a configuration, it is possible to achieve both increasing a rated output power and decreasing a cut-in wind speed to start power generation. It is possible to increase power generation efficiency.

In one embodiment of the technology, the wind turbine generator system may further include a control unit configured to control a power generation torque of the first motor generator and a power generation torque of the second motor generator. The wind turbine generator system may further include a temperature sensor configured to measure a temperature of the first motor generator and a temperature of the second motor generator. The control unit may be configured to reduce the power generation torque as the temperature measured by the temperature sensor increases. With such a configuration, the temperatures of the first and second motor generators are able to be controlled, so it is possible to increase the power generation efficiency and extend the service life of each of the motor generators.

In one embodiment of the technology, the wind turbine generator system may be a system for a hybrid electric vehicle. The ring gear may be coupled to a wheel. The planetary carrier may be coupled to an output shaft of an engine. With such a configuration, a unit mounted on a hybrid electric vehicle is able to be used as part of a wind turbine generator system.

### Configuration of Hybrid Electric Vehicle 2

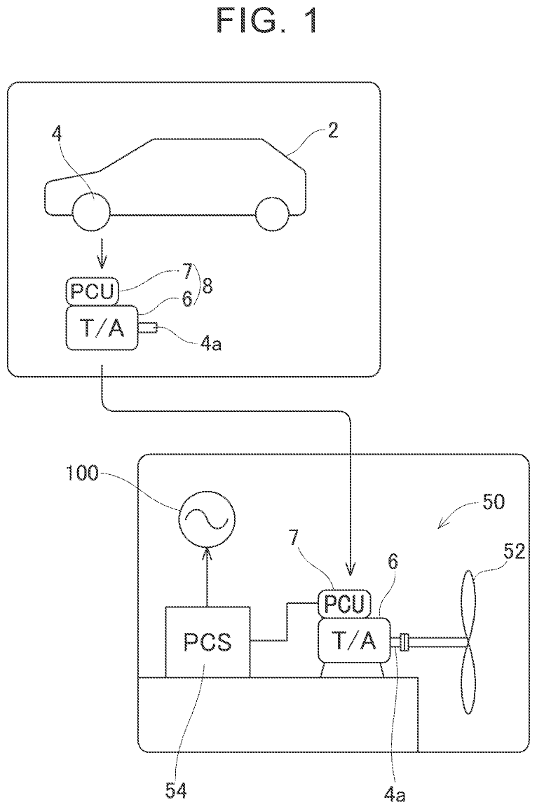

Initially, a hybrid unit 8 of a hybrid electric vehicle 2 will be described. As shown in FIG. 1, in a wind turbine generator system 50 of the present embodiment, the hybrid unit 8 removed from the hybrid electric vehicle 2 is used. The hybrid unit 8 is a power unit connected to wheels 4 in the hybrid electric vehicle 2. The hybrid unit 8 includes a transaxle 6 and a power control unit 7. The hybrid unit 8 may be a new product.

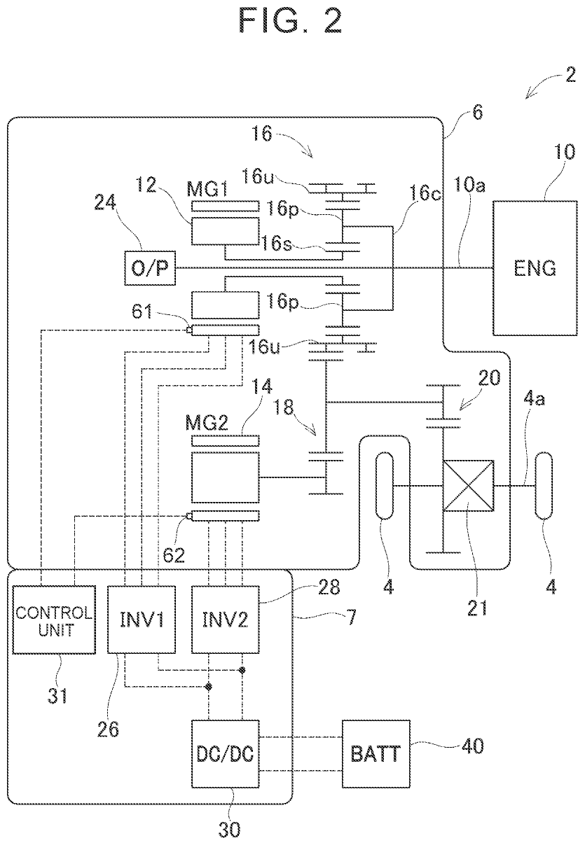

As shown in FIG. 2, the transaxle 6 further includes a second motor generator 14 and a planetary gear train 16. The planetary gear train 16 is located between an engine shaft 10a and a first motor generator 12. The engine shaft 10a is connected to the first motor generator 12 via the planetary gear train 16. The engine shaft 10a is also connected to the second motor generator 14 via the planetary gear train 16. The first motor generator 12 is a motor generator having a lower rated output power and a smaller starting torque than the second motor generator 14. In the drawings, the first motor generator 12 may be referred to as MG1, and the second motor generator 14 may be referred to as MG2.

The planetary gear train 16 includes a sun gear 16s, a plurality of planetary gears 16p, a planetary carrier 16c, and a ring gear 16u. The sun gear 16s is connected to the first motor generator 12. The planetary gears 16p are disposed around the sun gear 16s and meshed with the sun gear 16s. The planetary carrier 16c supports the planetary gears 16p such that the planetary gears 16p are rotatable. The planetary carrier 16c is connected to the engine shaft 10a. The ring gear 16u is located around the planetary gears 16p and meshed with the planetary gears 16p. The ring gear 16u is connected to the second motor generator 14 via a first speed reduction mechanism 18. The ring gear 16u is connected to axles 4a of the wheels 4 via a second speed reduction mechanism 20. A differential gear 21 is provided between the second speed reduction mechanism 20 and the axles 4a.

The transaxle 6 further includes a mechanical oil pump 24. The mechanical oil pump 24 is coupled to the engine shaft 10a and is driven by the rotation of the engine shaft 10a. The mechanical oil pump 24 is driven by the rotation of the engine shaft 10a to circulate lubricating oil in the transaxle 6. Thus, oil is able to be supplied to each of the component parts of the transaxle 6.

The power control unit 7 is combined with the transaxle 6. The power control unit 7 includes a first inverter 26, a second inverter 28, a DC-DC converter 30, and a control unit 31 for controlling these components. The control unit 31 may be a power control unit (PCU). The first inverter 26 is electrically connected to the first motor generator 12. The control unit 31 is capable of controlling a power generation torque of the first motor generator 12 via the first inverter 26. The second inverter 28 is electrically connected to the second motor generator 14. The control unit 31 is capable of controlling a power generation torque of the second motor generator 14 via the second inverter 28.

A temperature sensor 61 is provided for the first motor generator 12, and a temperature sensor 62 is provided for the second motor generator 14. Pieces of temperature data output from the temperature sensors 61, 62 are input to the control unit 31.

The DC-DC converter 30 is electrically connected to the first motor generator 12 via the first inverter 26 and is electrically connected to the second motor generator 14 via the second inverter 28. A battery 40 of the hybrid electric vehicle 2 is electrically connected to the DC-DC converter 30. The battery 40 has, for example, a plurality of lithium ion cells and is configured to be rechargeable. In the hybrid electric vehicle 2, the DC-DC converter 30 is capable of stepping up direct-current power from the battery 40 and supplying the direct-current power to the first inverter 26 and the second inverter 28. The first inverter 26 is capable of converting direct-current power from the DC-DC converter 30 to alternating-current power and supplying the alternating-current power to the first motor generator 12. Thus, the first motor generator 12 is able to operate on electric power supplied from the battery 40 to, for example, start the engine 10. Similarly, the second inverter 28 is capable of converting direct-current power from the DC-DC converter 30 to alternating-current power and supplying the alternating-current power to the second motor generator 14. Thus, the second motor generator 14 is able to operate on electric power supplied from the battery 40 to, for example, drive the wheels 4.

As described above, the first motor generator 12 is driven by the engine 10 to function as a generator. In this case, the first inverter 26 converts alternating-current power from the first motor generator 12 to direct-current power and supplies the direct-current power to the DC-DC converter 30. Then, the DC-DC converter 30 is able to step down direct-current power from the first inverter 26 and supply the direct-current power to the battery 40. On the other hand, the second motor generator 14 is also able to function as a generator to use regenerative braking in the hybrid electric vehicle 2. In this case, the second inverter 28 converts alternating-current power from the second motor generator 14 to direct-current power and supplies the direct-current power to the DC-DC converter 30. Then, the DC-DC converter 30 is able to step down direct-current power from the second inverter 28 and supply the direct-current power to the battery 40.

### Configuration of Wind Turbine Generator System 50

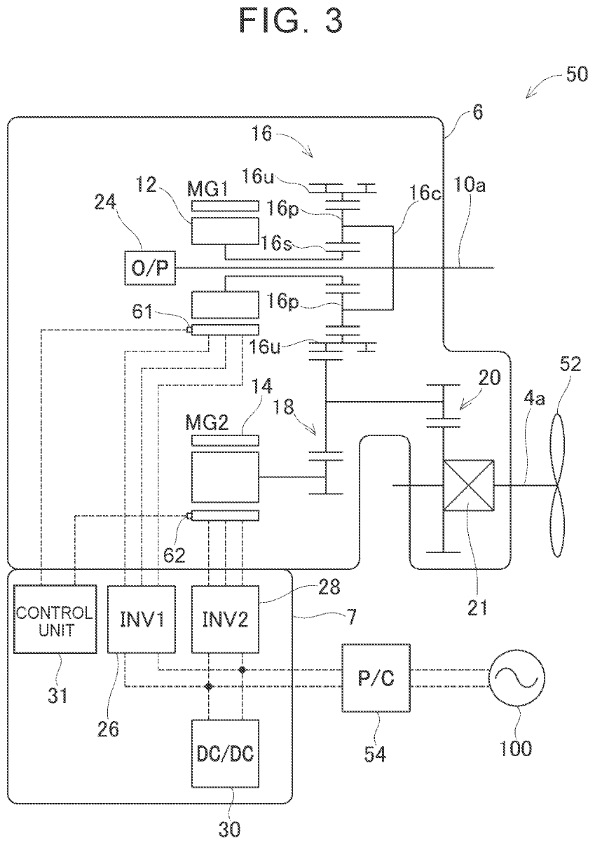

Next, the wind turbine generator system 50 in which the hybrid unit 8 is used will be described with reference to FIG. 1 and FIG. 3. The wind turbine generator system 50 includes blades 52 and a power conditioner 54 in addition to the hybrid unit 8. The power conditioner 54 is connected to the power control unit 7 and is interposed between an external electric power system 100 and the power control unit 7.

When the wind turbine generator system 50 is manufactured, initially, the hybrid unit 8 is removed from the hybrid electric vehicle 2. Subsequently, in the removed hybrid unit 8, the blades 52 are assembled to the axle 4a of the transaxle 6. Thus, the structure in which the first motor generator 12 is coupled to the sun gear 16s and the second motor generator 14 and the blades 52 are coupled to the ring gear 16u is finished. Nothing is connected to the engine shaft 10a. In the above structure, the ratio between the rotation speed of the second motor generator 14 and the rotation speed of the blades 52 is fixed. On the other hand, the ratio between the rotation speed of the first motor generator 12 and the rotation speed of the blades 52 is adjustable.

The power conditioner 54 is electrically connected to the power control unit 7. Electric power generated by the first motor generator 12 and the second motor generator 14 is supplied to the power conditioner 54 via the power control unit 7. The power conditioner 54 coordinates with the external electric power system 100 to make it possible to supply the generated electric power to the external electric power system 100. An electrical storage device may be connected to the power control unit 7 instead of or in addition to the power conditioner 54. Where necessary, a speed reduction gear, a speed increasing gear, or a transmission may be provided between the blades 52 and the axle 4a.

### Operation of Wind Turbine Generator System 50

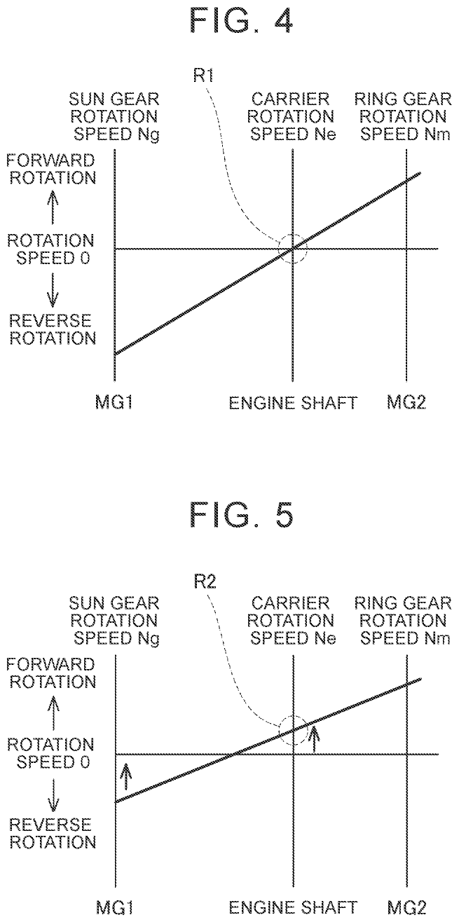

The operation of the wind turbine generator system 50 will be described with reference to the nomographs of FIG. 4 to FIG. 6. Each of the nomographs shows the relationship among sun gear rotation speed Ng, carrier rotation speed Ne, and ring gear rotation speed Nm.

FIG. 4 shows an example of the nomograph of a state where electric power is being generated by the second motor generator 14. When the rotation of the blades 52 is input to the axle 4a, the ring gear 16u rotates in a forward direction at the ring gear rotation speed Nm. The rotation of the ring gear 16u is transmitted to the second motor generator 14. The control unit 31 controls the second inverter 28 to apply a power generation torque to the second motor generator 14. Thus, electric power is able to be generated by the second motor generator 14. The sun gear 16s rotates in a reverse direction at the sun gear rotation speed Ng, so the first motor generator 12 rotates in the reverse direction at no load. The carrier rotation speed Ne of the planetary carrier 16c is zero. In other words, the engine shaft 10a is in an artificially locked state (see the region R1).

FIG. 5 shows an example of the nomograph of a state where electric power is being generated by the first motor generator 12 and the second motor generator 14. In a power generation state of FIG. 4, the first motor generator 12 is caused to generate a torque in the forward rotation direction. Specifically, the first inverter 26 is controlled to apply a power generation torque to the first motor generator 12. To generate a torque in the forward rotation direction in the first motor generator 12 rotating in a reverse direction, the first motor generator 12 operates as a generator. A torque in a direction to rotate the engine shaft 10a in a forward direction is generated in the sun gear 16s. Thus, the carrier rotation speed Ne increases (see the region R2). The amount of share of generated electric power between the first motor generator 12 and the second motor generator 14 is able to be controlled by power generation torques respectively applied to both the first motor generator 12 and the second motor generator 14 by the control unit 31.

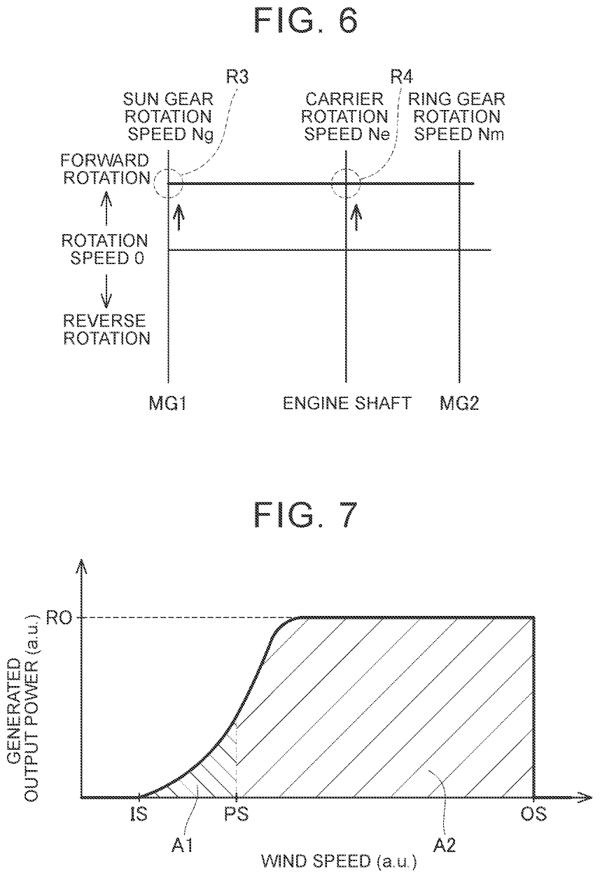

FIG. 6 shows an example of the nomograph of a planetary lock state. In the state of FIG. 4, the control unit 31 powers the first motor generator 12 via the first inverter 26. Thus, the first motor generator 12 rotates in the forward direction (see the region R3), and the carrier rotation speed Ne further increases (see the region R4). Then, when the carrier rotation speed Ne increases until the sun gear rotation speed Ng, the carrier rotation speed Ne, and the ring gear rotation speed Nm are equal to one another as shown in FIG. 6, the planetary gear train is in a locked state.

As described above, the wind turbine generator system 50 is enabled to change into a selected state between a state where the carrier rotation speed Ne (that is, the rotation speed of the engine shaft 10a) is zero (FIG. 4) and a state where the carrier rotation speed Ne is maximum (FIG. 6). In other words, the control unit 31 controls the rotation speed of the first motor generator 12 to make it possible to adjust the carrier rotation speed Ne (that is, the rotation speed of the engine shaft 10a). As the carrier rotation speed Ne is increased, the flow rate of lubricating oil circulated from the mechanical oil pump 24 is increased. Therefore, the carrier rotation speed Ne can be adjusted as needed according to a cooling condition and a lubricating condition of the component parts of the wind turbine generator system 50.

### Specific Example 1 of Control of Wind Turbine Generator System 50

FIG. 7 is a graph that shows an example of a power curve of the wind turbine generator system 50. In a region A1 from a cut-in wind speed IS to a predetermined wind speed PS, the control unit 31 applies a power generation torque to only the first motor generator 12. Thus, electric power is generated by using only the first motor generator 12. On the other hand, in a region A2 from the predetermined wind speed PS to a cut-out wind speed OS, the control unit 31 applies a power generation torque to each of the first motor generator 12 and the second motor generator 14. Thus, electric power is generated by both the first motor generator 12 and the second motor generator 14. In other words, when the input torque input from the blades 52 is less than a predetermined torque determined by the predetermined wind speed PS, electric power is generated by the first motor generator 12. On the other hand, when the input torque is greater than the predetermined torque, electric power is generated by both the first motor generator 12 and the second motor generator 14.

The first motor generator 12 is a motor generator having a smaller starting torque than the second motor generator 14. Therefore, by using only the first motor generator 12 in the region A1, the cut-in wind speed IS is reduced. In addition, by using the first motor generator 12 and the second motor generator 14 in the region A2, the rated output power RO is increased. It is possible to increase power generation efficiency.

### Specific Example 2 of Control of Wind Turbine Generator System 50

The control unit 31 is monitoring temperature data acquired from the temperature sensors 61, 62. Then, a power generation torque applied to the first motor generator 12 is reduced with an increase in the temperature of the first motor generator 12 to a predetermined temperature. A power generation torque applied to the second motor generator 14 is reduced with an increase in the temperature of the second motor generator 14 to the predetermined temperature. Thus, the temperature of the first motor generator 12 and the temperature of the second motor generator 14 are able to be controlled to the predetermined temperature or below, so it is possible to increase the power generation efficiency and extend the service life of each of the motor generators.

The control unit 31 generates a torque in the forward rotation direction in the first motor generator 12 when the temperature of at least one of the first motor generator 12 and the second motor generator 14 increases to the predetermined temperature 12. Thus, the engine shaft 10a is rotated to make it possible to drive the mechanical oil pump 24, so it is possible to cool the first motor generator 12 and the second motor generator 14.

### Effects

As described above, in the wind turbine generator system 50 of the present embodiment, the hybrid unit 8 for the hybrid electric vehicle 2 is used as part of the wind turbine generator system 50. Since the hybrid unit 8 is made of mass-produced vehicle parts, the hybrid unit 8 is much more inexpensive than parts intended for wind power generation. The wind turbine generator system 50 can be provided at low cost, so it is possible to promote further proliferation of renewable energy. The hybrid unit 8 is useful in availability as compared to parts intended for wind power generation. Since the accumulated know-how in vehicles is able to be used to maintain the hybrid unit 8, ease of maintenance is improved.

With the wind turbine generator system 50 of the specification, a driving torque input from the blades 52 is able to be distributed by the planetary gear train 16 to between the first motor generator 12 and the second motor generator 14. The rotation speed of the first motor generator 12 is allowed to be set independently of the rotation speed of the blades 52, so power generation is possible at an optimal operating point of the first motor generator 12 and the second motor generator 14. It is possible to optimize the overall power generation efficiency of the wind turbine generator system 50. Even in the case where one of the first motor generator 12 and the second motor generator 14 fails, the other one can generate electric power. It is possible to provide redundancy for failure.

The embodiments have been described in detail above; however, these are only illustrative and are not intended to limit the appended claims. The technology described in the appended claims also encompasses various modifications and changes from the specific examples illustrated above. The technical elements described in the specification or the drawings exhibit technical usability solely or in various combinations and are not limited to combinations of the appended claims at the time of filing the application. The technology illustrated in the specification and drawings can achieve multiple purposes at the same time and has technical usability by achieving one of those purposes.

### Modification

A shaft to which the blades 52 are assembled is not limited to the axle 4a. The blades 52 may be assembled to another rotary shaft coupled to the first motor generator 12 or the second motor generator 14, such as the engine shaft 10a of the transaxle 6.

The second motor generator 14 is an example of the drive motor generator. The first motor generator 12 is an example of the power motor generator. The states of FIG. 4 and FIG. 5 are examples of the first state. The state of FIG. 6 is an example of the second state.

What is claimed is:

1. A manufacturing method for a wind turbine generator system, the manufacturing method comprising:
preparing a transaxle including a drive motor generator and intended for a hybrid electric vehicle; and
assembling a blade to a rotary shaft coupled to the drive motor generator in the prepared transaxle.

2. The manufacturing method according to claim 1, wherein the rotary shaft of the transaxle is a shaft connected to a wheel of the hybrid electric vehicle when the transaxle is mounted on the hybrid electric vehicle.

3. The manufacturing method according to claim 2, wherein:
the transaxle includes a planetary gear train; and
the rotary shaft is connected to the drive motor generator via the planetary gear train.

4. The manufacturing method according to claim 3, wherein:
the transaxle includes a power motor generator; and
the rotary shaft is also connected to the power motor generator via the planetary gear train.

5. The manufacturing method according to claim 4, wherein the planetary gear train includes a sun gear connected to the power motor generator, and a ring gear connected to the drive motor generator and the blade.

6. A wind turbine generator system comprising:
a blade;
a first motor generator;
a second motor generator; and
a planetary gear train including a sun gear, a ring gear, and a planetary carrier, wherein:
the first motor generator is coupled to the sun gear; and
the blade and the second motor generator are coupled to the ring gear.

7. The wind turbine generator system according to claim 6, wherein:
a ratio between a rotation speed of the second motor generator and a rotation speed of the blade is fixed; and
a ratio between a rotation speed of the first motor generator and the rotation speed of the blade is adjustable.

8. The wind turbine generator system according to claim 6, further comprising a mechanical oil pump coupled to the planetary carrier, wherein the mechanical oil pump is configured to supply oil to component parts of the wind turbine generator system in response to rotation of the planetary carrier.

9. The wind turbine generator system according to claim 6, wherein:
the planetary gear train is configured to change in state between a first state where the ring gear is rotating in a forward direction and the sun gear is rotating in a reverse direction and a second state where the ring gear, the planetary carrier, and the sun gear are rotating in the forward direction; and
in the second state, the first motor generator is configured to generate a torque in a forward rotation direction.

10. The wind turbine generator system according to claim 6, further comprising a control unit configured to control a power generation torque of the first motor generator and a power generation torque of the second motor generator, wherein:
the first motor generator is a motor generator having a smaller starting torque than the second motor generator;
the control unit is configured to generate electric power by using the first motor generator when an input torque input from the blade is less than a predetermined value; and
the control unit is configured to generate electric power by using the first motor generator and the second motor generator when the input torque is greater than the predetermined value.

11. The wind turbine generator system according to claim 6, further comprising:
a control unit configured to control a power generation torque of the first motor generator and a power generation torque of the second motor generator; and
a temperature sensor configured to measure a temperature of the first motor generator and a temperature of the second motor generator, wherein
the control unit is configured to reduce the power generation torque as the temperature measured by the temperature sensor increases.

12. The wind turbine generator system according to claim 6, wherein:
the wind turbine generator system is a system for a hybrid electric vehicle;
the ring gear is coupled to a wheel; and
the planetary carrier is coupled to an output shaft of an engine.
